(19) United States
(12) Patent Application Publication
(10) Pub. No.: US 2026/0233906 A1
(43) Pub. Date: Aug. 13, 2026

(54) Lid with Supplements Discharge Arrangement for Beverage Container

(71) Applicant: Shanghai Yuhao Household Appliance Manufacturing Co., Ltd., Shanghai (CN)

(72) Inventor: Zhenming NI, San Marino, CA (US)

(21) Appl. No.: 19/052,240

(22) Filed: Feb. 12, 2025

(51) Int. Cl. B65D 51/28; B65D 47/08; B65D 51/32; B65D 81/32

(52) U.S. Cl. CPC B65D 51/2835; B65D 47/088; B65D 51/32; B65D 81/3222

(57) ABSTRACT

A lid for a beverage container includes a lid body having a beverage opening and a discharge opening, and a supplements discharge arrangement which includes a supplements discharge member detachably attached to the lid body. The supplements discharge member includes a main body having a storage cavity for storing a predetermined amount of beverage supplements, an actuation member provided on the main body, a punching member connecting to the actuation member and extending in the storage cavity, and a discharge membrane attached on the main body to normally prevent the beverage supplements from being discharged to the container cavity. When the actuation member is actuated, the punching member is arranged to be driven to break the discharge membrane so as to allow the beverage supplements to be discharged out of the storage cavity and dispose in the container cavity.

### BACKGROUND OF THE PRESENT INVENTION

### Field of Invention

The present invention relates to a beverage container, and more particularly to a lid for a beverage container comprising a supplements discharge arrangement, in which a supplements discharge member is arranged to selectively release a predetermined amount of supplements to the beverage container.

### Description of Related Arts

A conventional container, such as a beverage container for containing water, usually comprises a container body and a lid detachably attached on the container body. The container body has a container cavity for storing a predetermined amount of fluid, such as water. When a user wishes to consume beverage while on the go, the beverage, such as water or juice etc., must be pre-prepared and stored in the beverage container before the user brings it out with him.

A major disadvantage of the conventional beverage container such as the one mentioned above is that a user can only carry a single kind of beverage, such as juice. When the user carries the beverage container with him while he is on the go (example: while the user is exercising), he can only consume the liquid he bought with him. In certain occasions, a user may wish to just carry water (such as hot water) and mix the water with something else (such as infant formula or other supplements) while he is traveling. In these situations, the user must open the infant formula package and mix it with the hot water in the beverage container. There may be difficult or inconvenient circumstances so that the user may not be able to mix the supplements with the beverage carried in the beverage container. For example, the user may not be able to find a suitable table or supporting rack to perform the mixing.

Therefore, there is a need to develop a beverage container having a special lid which may allow the user to conveniently mix supplements with the beverage contained in the beverage container.

### SUMMARY OF THE PRESENT INVENTION

Certain variations of the present invention provide a lid comprising a supplements discharge arrangement for a beverage container so as to allow supplements to be conveniently and easily released and mixed with the beverage contained in the beverage container.

Certain variations of the present invention provide a beverage container comprising a lid with a supplements discharge arrangement, in which a user may carry a certain kind of beverage or supplements and conveniently mix them to become another kind of beverage at a later time (such as while he is traveling).

In one aspect of the present invention, it provides a lid for a beverage container having a container cavity, comprising:
a lid body detachably attached on the beverage container to selectively enclose the container cavity, the lid body having a beverage opening and a discharge opening, the beverage opening and the discharge opening communicating with the container cavity; and
a supplements discharge arrangement which comprises a supplements discharge member detachably attached on the lid body, the supplements discharge member comprising:
a main body having a storage cavity for storing a predetermined amount of beverage supplement, the storage cavity communicating with the container cavity;
an actuation member provided on the main body;
a punching member connecting to the actuation member and extending in the storage cavity; and
a discharge membrane attached on the main body to normally prevent the beverage supplements from being discharged to the container cavity, wherein when the actuation member is actuated, the punching member is arranged to be driven to break the discharge membrane so as to allow the beverage supplements to be discharged out of the storage cavity and dispose in the container cavity.

In another aspect of the present invention, it provides a beverage container, comprising:
a container body having a container cavity; and
a lid detachably attached on the container body, the lid comprising:
a lid body detachably attached on the container body to selectively enclose the container cavity, the lid body having a beverage opening and a discharge opening, the beverage opening and the discharge opening communicating with the container cavity; and
a supplements discharge arrangement which comprises a supplements discharge member detachably attached on the lid body, the supplements discharge member comprising:
a main body having a storage cavity for storing a predetermined amount of beverage supplement, the storage cavity communicating with the container cavity;
an actuation member provided on the main body;
a punching member connecting to the actuation member and extending in the storage cavity; and
a discharge membrane attached on the main body to normally prevent the beverage supplements from being discharged to the container cavity, wherein when the actuation member is actuated, the punching member is arranged to be driven to break the discharge membrane so as to allow the beverage supplements to be discharged out of the storage cavity and disposed in the container cavity.

This summary presented above is provided merely to introduce certain concepts and not to identify any key or essential features of the claimed subject matter.

### BRIEF DESCRIPTION OF THE DRAWINGS

FIG. 1 is a perspective view of a beverage container according to a preferred embodiment of the present invention.

FIG. 2 is a perspective view of a lid according to the preferred embodiment of the present invention.

FIG. 3 is an exploded perspective view of the lid according to the preferred embodiment of the present invention.

FIG. 4 is another perspective view of a lid of the beverage container according to the preferred embodiment of the present invention.

FIG. 5 is a sectional side view of the lid of the beverage container according to the preferred embodiment of the present invention.

FIG. 6 is a partially enlarged view of Section A of FIG. 5.

FIG. 7 is another partially enlarged view of Section B of FIG. 5.

FIG. 8 is a perspective view of a supplements discharge member of the lid according to the preferred embodiment of the present invention.

FIG. 9 is a perspective view of the lid according to the preferred embodiment of the present invention, illustrating that a stirring member is attached to a lid body.

FIG. 10 is a schematic diagram of a stirring member of the lid according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

In the following descriptions, it should also be appreciated that the terms “arrange” and “set” in the following description refer to the connecting relationship in the accompanying drawings for easy understanding of the present invention. For example, the “arrange” and “set” can refer to one element directly or indirectly set or arrange on another element. Therefore, the above terms should not be an actual connection limitation of the elements of the present invention.

It should also be appreciated that the terms “center”, “length”, “width”, “thickness”, “top”, “bottom”, “front”, “rear”, “left”, “right”, vertical”, “horizontal“, ”upper”, “lower”, “interior”, and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

Moreover, it should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection can refer to permanent connection or detachable connection. Therefore, the above terms should not be an actual connection limitation of the elements of the present invention.

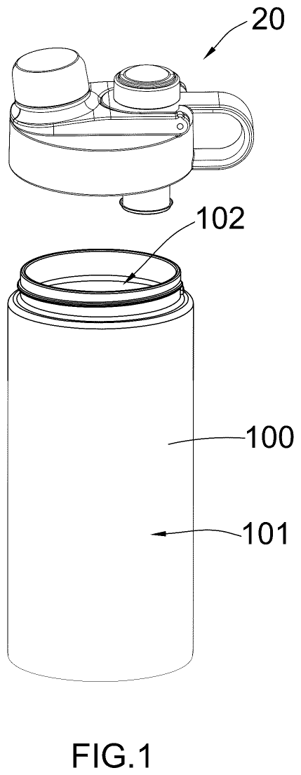

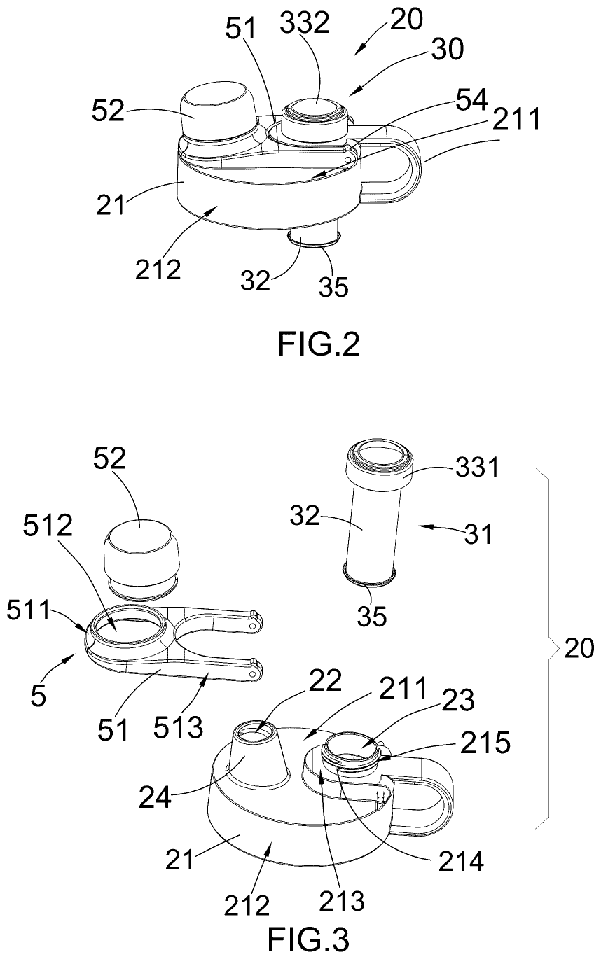

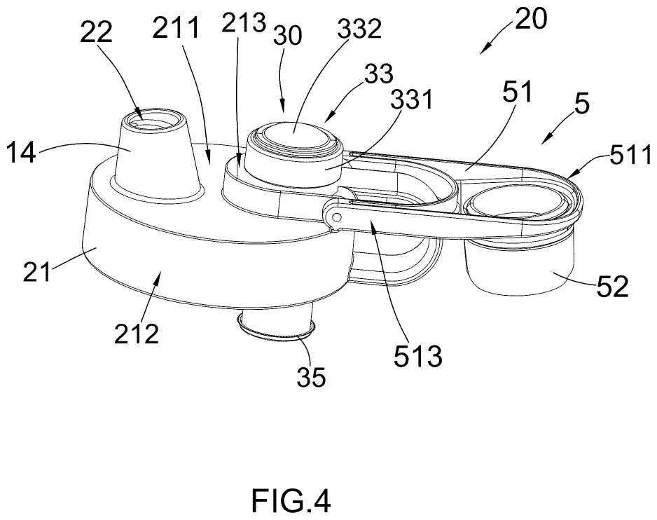

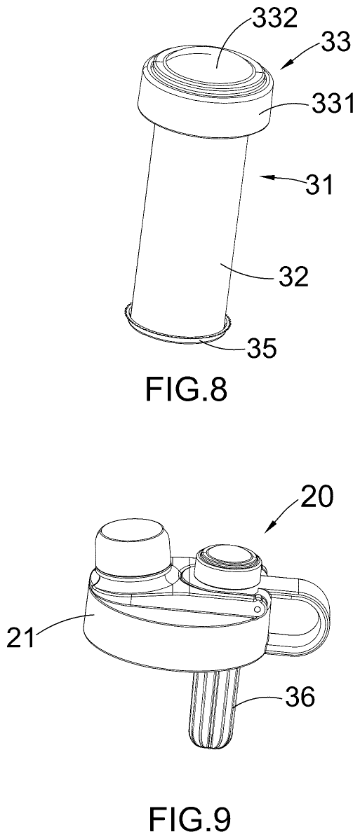

Referring to FIG. 1 to FIG. 10 of the drawings, a beverage container according to a preferred embodiment of the present invention is illustrated. The beverage container may comprise a container body 100 having a container cavity 101, and a lid 20 detachably attached on the container body 100. The beverage container may be used for storing a predetermined amount of liquid, such as water, and may be carried in a portable manner.

The lid 20 may comprise a lid body 21 and a supplements discharge arrangement 30. The lid body 21 may be detachably attached to the container body 100 to selectively enclose the container cavity 101. The lid body 21 may have a beverage opening 22 and a discharge opening 23. The beverage opening 22 and the discharge opening 23 may both communicate with the container cavity 101.

The supplements discharge arrangement 30 may comprises a supplements discharge member 31 detachably attached to the lid body 21. The supplements discharge member 31 may comprise a main body 32, an actuation member 33 operatively provided on the main body 32, at least one punching member 34, and a discharge membrane 35.

The main body 32 may have a storage cavity 321 for storing a predetermined amount of beverage supplements. The storage cavity 321 may communicate with the container cavity 101 through the discharge membrane 35.

The punching member 34 may be connected to the actuation member 33 and may extend in the storage cavity 321.

The discharge membrane 35 may be attached to the main body 32 to normally prevent the beverage supplements from being discharged to the container cavity 101, wherein when the actuation member 33 is actuated, the punching member 34 is arranged to be driven to break the discharge membrane 35 so as to allow the beverage supplements to be discharged out of the storage cavity 321 and disposed in the container cavity 101.

According to the preferred embodiment of the present invention, the beverage container may be utilized to store liquid, such as water. The lid 20 may be detachably attached to the lid container body 100 so as to selectively cover the container cavity 101. The container body 100 may be configured from plastic or metallic material, and may have a substantially circular cross sectional shape (or any other cross sectional shapes).

The lid body 21 may have a corresponding cross sectional shape for detachably and fittingly attaching to the container body 100. As shown in FIG. 1 of the drawings, the lid body 21 may have a top cover panel 211 and a peripheral panel 212 peripherally and downwardly extending from the top cover panel 211. The peripheral panel 212 may detachably engage with a top edge portion 102 of the container body 100, preferably through threads or other structures.

The beverage opening 22 and the discharge opening 23 may be spacedly formed on the top cover panel 211. When the lid body 21 is detachably attached to the container body 100, the beverage opening 22 and the discharge opening 23 may communicate with the container cavity 101. Referring to FIG. 3 of the drawings, the lid 2 may further comprise a mouthpiece 24 provided on the lid body 21, wherein the beverage opening 22 may be formed at the mouthpiece 24. The mouthpiece 24 may be designed for allowing a user to put it in his mouth so that the beverage contained in the beverage cavity 101 may be discharged through the beverage opening 22 and easily consumed by the user.

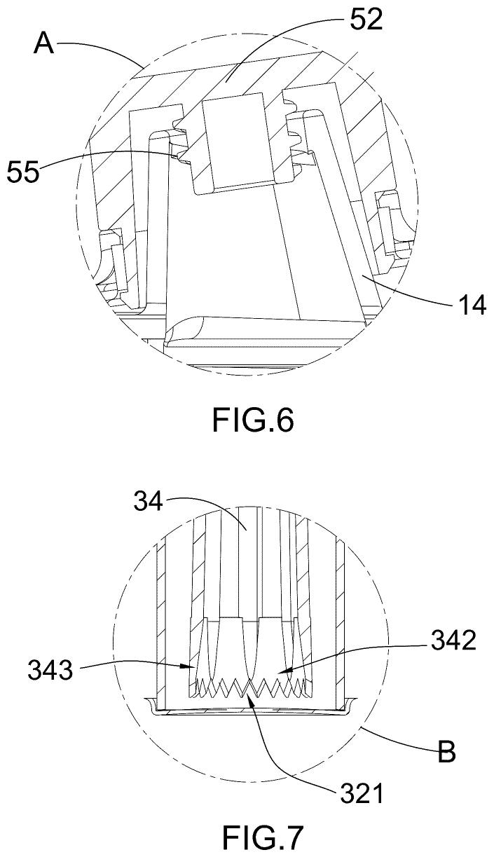

In this particular embodiment of the present invention, the mouthpiece 24 may form a conical structure and may protrude from the top cover panel 211 of the lid body 21. The lid 2 may further comprise a mouthpiece protection mechanism 5 for detachably covering the mouthpiece 24. More specifically, the mouthpiece protection mechanism 5 may comprise a connecting frame 51 and a mouthpiece cover 52 movably provided on the connecting frame 51. The connecting frame 51 may be pivotally connected to the lid body 21 so as to selectively and detachably connect the mouthpiece cover 52 to the mouthpiece 24. Thus, a user may be able to pivotally move the connecting frame 51 to selectively cover the beverage opening 22. As shown in FIG. 6 of the drawings, the mouthpiece cover 52 may be detachably connected to the mouthpiece 24 through a plurality of threads 55 formed on the mouthpiece cover 52 and the mouthpiece 24.

In this particular embodiment of the present invention, the connecting frame 51 may be configured to have a head portion 511 having a through hole 512, and a plurality of connecting legs 513 extending from the head portion 511, wherein the mouthpiece cover 52 may be movably connected to the head portion 511 and penetrate through the through hole 512.

The lid body 21 may form a supporting platform 213 and a protruding tube 214 upwardly protruding from the supporting platform 213. The supporting platform 213 may extend from the top cover panel 211 so as to form an elevated structure with respect to the top cover panel 211, wherein the connecting legs 513 of the connecting frame 51 may be pivotally connected to the supporting platform 213. The discharge opening 23 may be formed in the protruding tube 214 for communicating with the container cavity 101 when the lid 2 is attached on the container body 100, as shown in FIG. 3 of the drawings.

On the other hand, the supplements discharge member 31 may detachably engage with the discharge opening 23 so that the main body 32 may be selectively inserted in the protruding tube 214. The main body 32 of the supplements discharge member 31 may be configured as having an elongated and tubular structure and may have an external diameter corresponding to that of the discharge opening 23. Thus, the main body 32 may be selectively inserted in the protruding tube 214. A predetermined amount of supplements, such as vitamins powders, concentrated fruit juice, or other supplements, may be stored in the storage cavity 321 of the main body 32. The main body 32 may extend in the container cavity 101 so that when the discharge membrane 35 is broken, the supplements may be released and mix with the beverage contained in the container cavity 101. The protruding tube 214 may have a threaded portion 215 for engaging with the actuation member 33.

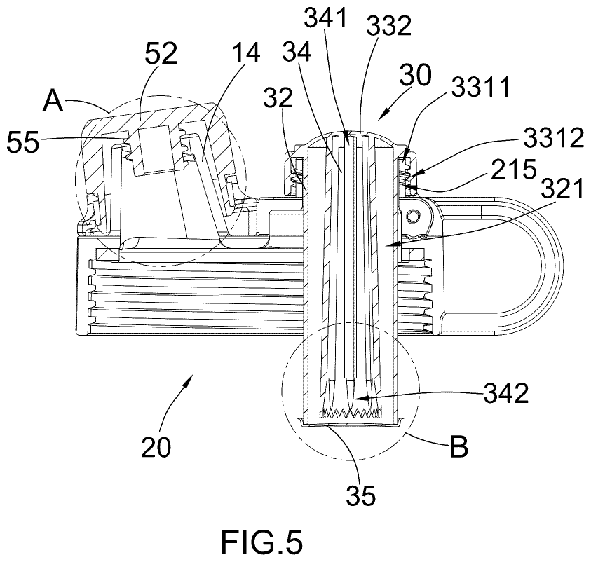

Referring to FIG. 5 of the drawings, the actuation member 33 may be provided on top of the main body 32 for actuating the punching member 34. The actuation member 33 may comprise an engagement cap 331 detachably engaging with the protruding tube 214, and a depressing button 332 provided on the engagement cap 331. The engagement between the engagement cap 331 and the protruding tube 214 may be accomplished through threads. Thus, the engagement cap 331 may have an engagement cavity 3311 and a plurality of engagement threads 3312 formed on an inner sidewall of the engagement cavity 3311, wherein the engagement threads 3312 may detachably engage with the threaded portion 215 of the protruding tube 215. An internal diameter of the engagement cap 331 may be larger than an external diameter of the protruding tube 214.

The depressing button 332 of the actuation member 33 may be provided on top of the engagement cap 331, wherein the punching member 34 may extend from the depressing button 332 to the discharge membrane 35 in the main body 32 of the supplements discharge member 31. When a user presses the depressing button 332, the depressing button 332 may slightly deform so as to drive the punching member 34 to move in a corresponding direction. Thus, the depressing button 332 may be configured from an elastic material such as rubber material so that a user may be able to conveniently apply force on the depressing button 332 for driving the punching member 34 in the manner described above. The depressing button 332 may be shaped and designed to have a slightly convex contour when viewed from an exterior of the protruding tube 214.

According to the preferred embodiment of the present invention, the supplements discharge arrangement 30 may comprise a plurality of (but at least one) punching members 34 extending from the depressing button 332. Each of punching members 34 may be elongated in shape and may have a top connecting portion 341 connecting to the depressing button 332, and a bottom punching portion 342 provided on top of the discharge membrane 35. Each of the punching members 34 may have a plurality of teeth 321 formed at the bottom punching portion 342. The bottom punching portions 342 of the punching members 34 may be integrally connected to form an annular punching tip portion 343.

It is worth mentioning that when the punching members 34 are driven to cut the discharge membrane 35, the teeth 321 are arranged to break those parts of the discharge membrane 35 which are in direct contact with the teeth 321. Other parts of the discharge membrane 35 are arranged to keep intact. As a result, the discharge membrane 35 may still be attached to the main body 32 of the supplements discharge member 31 when the discharge membrane 35 is broken by the teeth 321. This prevents the discharge membrane 35 from being detached and falling to the container cavity 101. The discharge membrane 35 may be configured from aluminum or other suitable material. The discharge membrane 35 may be made to be thin enough so as to allow effective punching by the teeth 321 of the punching members 34.

Moreover, since the depressing button 332 may be configured from elastic and deformable material, when a user ceases applying a depressing force to the depressing button 332, the depressing button 332 may return to its original shape and drive the punching member 34 to move away from the discharge membrane 35. This prevents the punching member 34 from interrupting the release of the supplements from the storage cavity 321.

In an alternative mode of the present invention, the bottom punching portions 342 of the punching members 34 may be integrally connected to form the annular punching tip portion 343, wherein the annular punching tip portion 343 may allow the supplements from being discharged from the storage cavity 321 even if the punching members 34 do not return to their original positions because of the annular or ring-shaped structure of the annular punching tip portion 343.

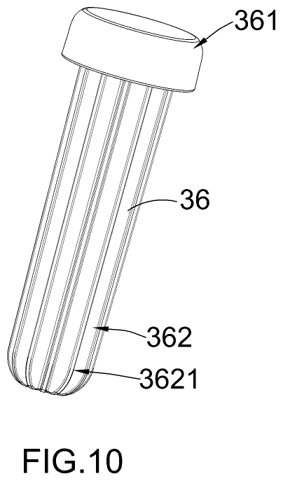

Referring to FIG. 9 to FIG. 10 of the drawings, the supplements discharge arrangement 30 may further comprise a stirring member 36 detachably attached to the lid body 21 and extend in the container cavity 101 so as to allow a user to thoroughly mix the supplements with the beverage in the container cavity 101. Specifically, when the lid 20 is attached to the beverage container 100, a user may detachably attach the supplements discharge member 31 to the lid body 21 through the discharge opening 23 and release the supplements to the container cavity 101. The supplements may then be mixed with the beverage contained in the container cavity 101.

After that, the user may detach the supplements discharge member 31 from the lid body 21 and attach the stirring member 36 to the lid body 21 also through the discharge opening 23. The user may then shake the container body 100 and use the stirring member 36 to thoroughly mix the supplements with the beverage.

In this preferred embodiment of the present invention, the stirring member 36 may have a connecting portion 361 detachably connected to the protruding tube 214, and an elongated stirring portion 362 extending from the connecting portion 361. The connecting portion 361 may be configured to have a plurality of elongated slots 3621 for allowing effective mixing of the liquid and the supplements in the container cavity 101. The connecting portion 361 may be detachably connected to the protruding tube 214 through threads. The elongated stirring portion 362 may penetrate through the discharge opening 23 and the protruding tube 214 so as to access the container cavity 101. A user may be able to shake the beverage container to thoroughly mix the beverage with the supplements released to the container cavity 101.

The operation of the present invention is as follows: a user may carry the beverage container described above while he is traveling. The container body 101 may contain a predetermined kind of beverage, such as water. The lid 20 may be attached to the container body 101. The user may select a supplements discharge member 31 with a predetermined supplements contained in the main body 32. For example, the supplements in this case may be concentrated lemon juice. The user may optionally carry with him the stirring member 36 described above.

While the user is traveling, he may simply detach the mouthpiece cover 52 from the mouthpiece 24 and consume the beverage in the container body 101 (such as water). When the user wishes to add the supplements to the beverage, he may simply need to press the depressing button 332 so that the depressing button 332 may drive the punching member 34 to break the discharge membrane 35. When this happens, the supplements (such as the concentrated lemon juice as described above) in the main body 32 of the supplements discharge member 31 may be released to the container body 101 and mix with the beverage.

Optionally, the user may detach the supplements discharge member 31 from the lid body 21 and attach the stirring member 36 thereto. After that, the user may shake the container body 101 and thoroughly mix the supplements with the beverage.

One skilled in the art would appreciate that several supplements discharge members 31 may be manufactured so as to carry different supplements so that the user may choose any one or several supplements discharge members 31 to carry with him.

The present invention, while illustrated and described in terms of a preferred embodiment and several alternatives, is not limited to the particular description contained in this specification. Additional alternative or equivalent components could also be used to practice the present invention.

1. A lid for a beverage container having a container cavity, comprising:
a lid body detachably attached on the beverage container to selectively enclose the container cavity, the lid body having a beverage opening and a discharge opening, the beverage opening and the discharge opening communicating with the container cavity; and
a supplements discharge arrangement which comprises a supplements discharge member detachably attached on the lid body, the supplements discharge member comprising:
a main body having a storage cavity for storing a predetermined amount of beverage supplements, the storage cavity communicating with the container cavity;
an actuation member provided on the main body;
at least one punching member connecting to the actuation member and extending in the storage cavity; and
a discharge membrane attached to the main body to normally prevent the beverage supplements from being discharged to the container cavity, wherein when the actuation member is actuated, the punching member is arranged to be driven to break the discharge membrane so as to allow the beverage supplements to be discharged out of the storage cavity and disposed in the container cavity.

2. The lid, as recited in claim 1, wherein the lid body has a top cover panel and a peripheral panel peripherally and downwardly extending from the top cover panel, wherein the beverage opening and the discharge opening are spacedly formed on the top cover panel.

3. The lid, as recited in claim 2, wherein the lid body has a supporting platform and a protruding tube upwardly protruding from the supporting platform, wherein the discharge opening is formed in the protruding tube for communicating with the container cavity when the lid is attached on the container body, the supplements discharge member being detachably engaged with the discharge opening so that the main body is to be selectively inserted in the protruding tube.

4. The lid, as recited in claim 3, wherein the actuation member comprises an engagement cap detachably engaging with the protruding tube, and a depressing button provided on the engagement cap, the engagement between the engagement cap and the protruding tube are accomplished through threads, the depressing button of the actuation member being operatively provided on top of the engagement cap.

5. The lid, as recited in claim 4, wherein the punching member extends from the depressing button to the discharge membrane in the main body of the supplements discharge member, so that when the depressing button is depressed, the depressing button is arranged to slightly deform and drive the punching member to move in a corresponding direction for breaking the discharge membrane.

6. The lid, as recited in claim 5, wherein the supplements discharge arrangement further comprises a plurality of punching members extending from the depressing button, each of the punching members being elongated in shape and having a top connecting portion connecting to the depressing button, and a bottom punching portion provided on top of the discharge membrane, each of the punching members having a plurality of teeth formed at the bottom punching portion.

7. The lid, as recited in claim 6, wherein the bottom punching portions of the punching members are integrally connected to form an annular punching tip portion.

8. The lid, as recited in claim 7, wherein the discharge membrane is attached on the main body of the supplements discharge membrane in such a manner that when at least one of the punching members is driven to cut the discharge membrane, the teeth are arranged to break the discharge membrane which are in direct contact with the teeth while at the same time the discharge membrane is kept attaching to the main body of the supplements discharge member.

9. The lid, as recited in claim 8, wherein the supplements discharge arrangement further comprises a stirring member detachably attached to the lid body and extending in the container cavity so as to allow a user to thoroughly mix the supplements with the beverage in the container cavity.

10. The lid, as recited in claim 9, wherein the stirring member has a connecting portion detachably connected to the protruding tube, and an elongated stirring portion extending from the connecting portion, the elongated stirring portion having a plurality of elongated slots.

11. A beverage container, comprising:
a container body having a container cavity; and
a lid detachably attached on the container body, the lid comprising:
a lid body detachably attached on the container body to selectively enclose the container cavity, the lid body having a beverage opening and a discharge opening, the beverage opening and the discharge opening communicating with the container cavity; and
a supplements discharge arrangement which comprises a supplements discharge member detachably attached on the lid body, the supplements discharge member comprising:
a main body having a storage cavity for storing a predetermined amount of beverage supplements, the storage cavity communicating with the container cavity;
a punching member connecting to the actuation member and extending in the storage cavity; and
a discharge membrane attached on the main body to normally prevent the beverage supplements from being discharged to the container cavity, wherein when the actuation member is actuated, the punching member is arranged to be driven to break the discharge membrane so as to allow the beverage supplements to be discharged out of the storage cavity and disposed in the container cavity.

12. The beverage container, as recited in claim 11, wherein the lid body has a top cover panel and a peripheral panel peripherally and downwardly extending from the top cover panel, wherein the beverage opening and the discharge opening are spacedly formed on the top cover panel.

13. The beverage container, as recited in claim 12, wherein the lid body has a supporting platform and a protruding tube upwardly protruding from the supporting platform, wherein the discharge opening is formed in the protruding tube for communicating with the container cavity when the lid is attached on the container body, the supplements discharge member being detachably engaged with the discharge opening so that the main body is to be selectively inserted in the protruding tube.

14. The beverage container, as recited in claim 13, wherein the actuation member comprises an engagement cap detachably engaging with the protruding tube, and a depressing button provided on the engagement cap, the engagement between the engagement cap and the protruding tube are accomplished through threads, the depressing button of the actuation member being operatively provided on top of the engagement cap.

15. The beverage container, as recited in claim 14, wherein the punching member extends from the depressing button to the discharge membrane in the main body of the supplements discharge member, so that when the depressing button is depressed, the depressing button is arranged to slightly deform and drive the punching member to move in a corresponding direction for breaking the discharge membrane.

16. The beverage container, as recited in claim 15, wherein the supplements discharge arrangement further comprises a plurality of punching members extending from the depressing button, each of the punching members being elongated in shape and having a top connecting portion connecting to the depressing button, and a bottom punching portion provided on top of the discharge membrane, each of the punching members having a plurality of teeth formed at the bottom punching portion.

17. The beverage container, as recited in claim 16, wherein the bottom punching portions of the punching members are integrally connected to form an annular punching tip portion.

18. The beverage container, as recited in claim 17, wherein the discharge membrane is attached on the main body of the supplements discharge membrane in such a manner that when at least one of the punching members is driven to cut the discharge membrane, the teeth are arranged to break the discharge membrane which are in direct contact with the teeth while at the same time the discharge membrane is kept attaching to the main body of the supplements discharge member.

19. The beverage container, as recited in claim 18, wherein the supplements discharge arrangement further comprises a stirring member detachably attached to the lid body and extending in the container cavity so as to allow a user to thoroughly mix the supplements with the beverage in the container cavity.

20. The beverage container, as recited in claim 19, wherein the stirring member has a connecting portion detachably connected to the protruding tube, and an elongated stirring portion extending from the connecting portion, the elongated stirring portion having a plurality of elongated slots.
